(19) United States
(12) Patent Application Publication
(10) Pub. No.: US 2024/0275116 A1
(43) Pub. Date: Aug. 15, 2024

(54) MULTICORE FIBER LASER WITH INTEGRATED HIGH-BRIGHTNESS SIGNAL COMBINER

(71) Applicant: Lumentum Operations LLC, San Jose, CA (US)

(72) Inventors: Richard D. FAULHABER, San Carlos, CA (US); Martin H. MUENDEL, Oakland, CA (US); Patrick GREGG, Sunnyvale, CA (US)

(21) Appl. No.: 18/194,242

(22) Filed: Mar. 31, 2023

Related U.S. Application Data
(60) Provisional application No. 63/485,170, filed on Feb. 15, 2023.

(51) Int. Cl. H01S 3/067; H01S 3/094

(52) U.S. Cl. CPC H01S 3/06737; H01S 3/06783; H01S 3/094007

(57) ABSTRACT

In some implementations, an optical system includes a multicore input fiber comprising multiple cores that are each configured to support an independent singlemode laser; a delivery fiber comprising a single core configured to support multiple modes; and a signal combiner, coupled to the multicore input fiber and coupled to the delivery fiber. In some implementations, the signal combiner is configured to receive multiple independent singlemode laser inputs from the multicore input fiber and to combine the multiple independent singlemode laser inputs into a multimode output that is provided to the delivery fiber.

### CROSS-REFERENCE TO RELATED APPLICATION

This patent application claims priority to U.S. Provisional Patent Application No. 63/485,170, filed on Feb. 15, 2023, and entitled “MULTICORE LASER WITH INTEGRATED HIGH-BRIGHTNESS SIGNAL COMBINER.” The disclosure of the prior application is considered part of and is incorporated by reference into this patent application.

### TECHNICAL FIELD

The present disclosure relates generally to a high-power fiber laser architecture and to a laser architecture that includes a multicore fiber supporting several independent singlemode lasers with an integrated high-brightness signal combiner.

### BACKGROUND

Laser power scaling includes techniques to increase an output power from a laser without changing the geometry, shape, or principle of operation of the laser. Power scalability, which is generally considered an important advantage in laser design, usually requires a more powerful pump source, stronger cooling, an increase in size, and/or a reduction in background loss in a laser resonator and/or a gain medium. For example, one approach to achieve power scalability is to use a master oscillator power amplifier (MOPA) architecture. For example, in a MOPA system, the master oscillator produces a highly coherent beam, and an optical amplifier is used to increase the power of the beam while preserving the main properties of the beam.

### SUMMARY

In some implementations, an optical system includes a pump laser source; a multicore fiber laser comprising: an oscillator comprising an input side coupled to the pump laser source and an output side, wherein the oscillator comprises: an active fiber comprising multiple singlemode active fiber cores to convert pump light generated by the pump laser source into signal light; multiple first reflectors, respectively associated with the multiple singlemode active fiber cores, that are each configured to operate as a high reflector (HR) on the input side of the oscillator; and multiple second reflectors, respectively associated with the multiple singlemode active fiber cores, that are each configured to operate as an output coupler (OC) on the output side of the oscillator; and a power amplifier coupled to the output side of the oscillator, wherein the power amplifier comprises multiple cores that are matched to the multiple singlemode active fiber cores of the oscillator; a multimode delivery fiber; and a signal combiner, integrated with the multicore fiber laser, configured to receive multiple singlemode laser inputs from the multicore fiber laser and to combine the multiple singlemode laser inputs into a multimode output that is provided to the multimode delivery fiber.

In some implementations, an optical system includes a multicore input fiber comprising multiple cores that are each configured to support an independent singlemode laser; a delivery fiber comprising a single core configured to support multiple modes; and a signal combiner, coupled to the multicore input fiber and to the delivery fiber, wherein the signal combiner is configured to receive multiple independent singlemode laser inputs from the multicore input fiber and to combine the multiple independent singlemode laser inputs into a multimode output that is provided to the delivery fiber.

In some implementations, a method for operating an optical system includes receiving, by a signal combiner, multiple independent singlemode laser inputs from a multicore input fiber that comprises multiple cores that are each configured to support an independent singlemode laser, of the multiple independent singlemode laser inputs; combining, by the signal combiner, the multiple independent singlemode laser inputs into a multimode output; and providing, by the signal combiner, the multimode output to a delivery fiber comprising a single core configured to support multiple modes.

### BRIEF DESCRIPTION OF THE DRAWINGS

FIG. 1A is a diagram illustrating an example of a master oscillator power amplifier (MOPA) laser architecture.

FIG. 1B is a diagram illustrating an example of power scaling a MOPA laser architecture using an external signal combiner.

FIG. 2A is a diagram illustrating examples of a multicore laser architecture that includes an integrated high-brightness signal combiner.

FIG. 2B is a diagram illustrating one or more examples of a multicore oscillator that may be used in a multicore laser architecture with an integrated high-brightness signal combiner.

FIGS. 3A-3B are diagrams illustrating example cross-sections of a multicore active fiber that may be used in a multicore laser architecture that includes an integrated high-brightness signal combiner.

FIGS. 4A-4C are diagrams illustrating example interfaces to couple a multicore oscillator and a power amplifier in a MOPA laser architecture.

FIGS. 5A-5C are diagrams illustrating examples of an integrated high-brightness signal combiner that may be used in a multicore laser architecture.

FIG. 6 is a diagram illustrating an example process for operating an optical system that includes a multicore laser architecture with an integrated high-brightness signal combiner.

### DETAILED DESCRIPTION

The following detailed description of example implementations refers to the accompanying drawings. The same reference numbers in different drawings may identify the same or similar elements.

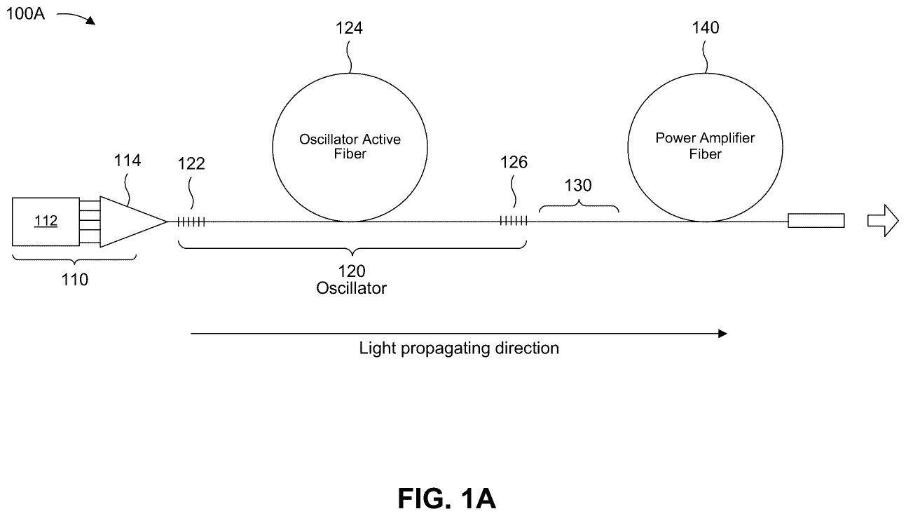

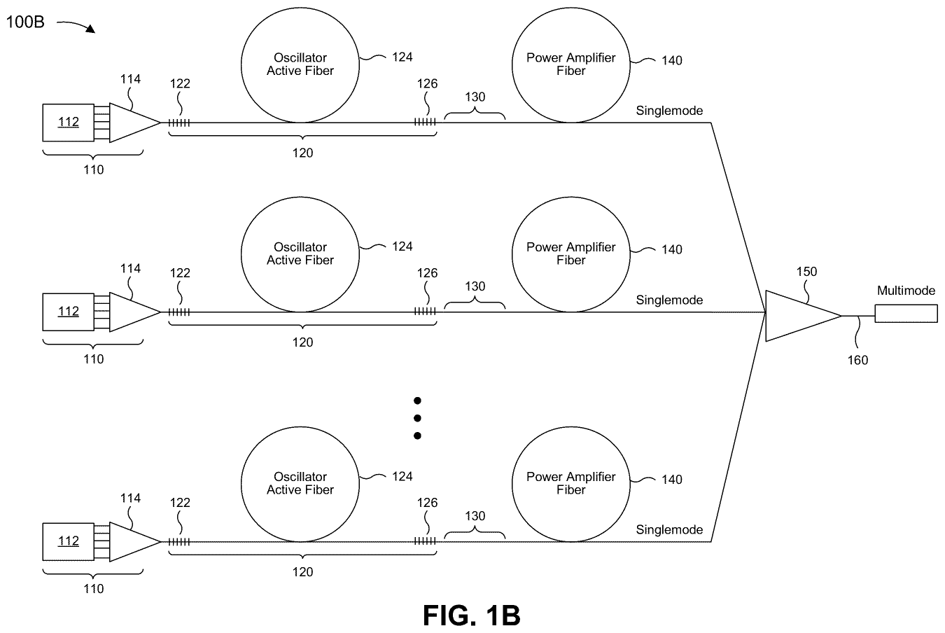

FIG. 1A is a diagram illustrating an example 100A of a master oscillator power amplifier (MOPA) laser architecture, and FIG. 1B is a diagram illustrating an example 100B of power scaling the MOPA laser architecture using an external signal combiner.

As described herein, laser power scaling generally refers to techniques that may be used to increase an output power from a laser without changing the geometry, shape, or principle of operation of the laser. Power scalability, which is considered an important advantage in laser design, usually requires a more powerful pump source, stronger cooling, an increase in size, and/or a reduction in background loss in a laser resonator and/or a gain medium. For example, one approach to achieve power scalability in a laser architecture is to use a MOPA architecture, where the master oscillator produces a highly coherent beam, and an optical power amplifier is used to increase the power of the beam while preserving the main properties of the beam. For example, in a MOPA architecture, the output from a low-power, single-frequency laser oscillator may be injected unidirectionally into an optical amplifier with greater output power capacity. A special case is a master oscillator fiber amplifier (MOFA), where the power amplifier is a fiber device. In other cases, a MOPA may include a solid-state bulk laser and a bulk amplifier, or a tunable external cavity diode laser and a semiconductor optical amplifier.

For example, referring to FIG. 1A, example 100A depicts a MOPA laser architecture that includes a multi-kilowatt (kW) pump source 110 comprising a set of laser diodes 112, a combiner 114, and a set of output fibers coupling the set of laser diodes 112 and the combiner 114. As further shown, the MOPA laser architecture may include a master oscillator 120 configured to produce a highly coherent beam, where the master oscillator 120 may comprise a first reflector 122 (e.g., a first fiber Bragg grating (FBG)), an active fiber 124, and a second reflector 126 (e.g., a second FBG). For example, the first reflector 122 may be used as a high reflector (HR) to reflect a high percentage of light emitted from the active fiber 124 between the combiner 114 and an input end of the active fiber 124, and the second reflector 126 may be used as an output coupler (OC) at an output end of the active fiber 124. The MOPA laser architecture may further include a power amplifier 140, and a passive fiber 130 coupling the output end of the oscillator 120 to the power amplifier 140 (e.g., via the second reflector 126 configured as the OC at the output end of the active fiber 124), as well as various other components in the optical chain (e.g., filters for undesired wavelengths or unabsorbed pump) or the like.

Although a MOPA configuration may be more complex than a laser that can directly produce the required output power, a MOPA configuration may achieve a required performance more easily (e.g., in terms of linewidth, wavelength tuning range, beam quality, or pulse duration) in cases where the required output power is high. In addition, a MOPA configuration may be used to modulate a low-power seed laser or may use an optical modulator between the seed laser (e.g., the oscillator 120) and the power amplifier 140 rather than modulating a high-power device directly, may use an existing laser and an existing amplifier (or amplifier chain) and thereby obviate a need to develop a new laser with a higher output power, and/or may use an amplifier that has lower optical intensities compared with the intracavity intensities in a laser.

However, power scaling a MOPA laser architecture to higher and higher powers is challenging. For example, the oscillator 120 in a MOPA laser architecture should be maintained as near to singlemode as possible for stability, which is challenging because converting pump light to signal light in the oscillator 120 is limited by stimulated Raman scattering (SRS), stimulated Brillouin scattering (SBS), or other nonlinear effects that pose serious hurdles to power scaling a singlemode laser. In particular, SRS is a nonlinear optical effect where energy from an optical beam is converted to a longer wavelength via vibrational and/or rotational modes or phonons being excited in the molecules of a glass medium. While this process may be useful for certain applications (e.g., to turn an optical fiber into a Raman amplifier or a tunable Raman laser), SRS is undesirable for multi-kW continuous wave (CW) industrial fiber lasers or quasi-CW kW fiber lasers used in the cutting and welding industries. For example, in industrial applications, SRS may transfer energy from one wavelength to another wavelength and/or limit the power that can propagate without unwanted loss and/or heating, which may negatively impact the industrial processes and/or cause damage to equipment. As power levels for industrial kW fiber lasers continue to increase, SRS, SBS, and other nonlinear effects become more problematic, and a need arises for techniques to suppress the nonlinear effects.

In some cases, power scaling in a MOPA laser architecture may be achieved by increasing a core diameter and/or a numerical aperture (NA) of the laser. However, increasing the core diameter and/or NA of the laser sacrifices brightness as a tradeoff for the increase in power. In other cases, power scaling in a MOPA laser architecture may be achieved by combining multiple lasers with an external signal combiner. For example, referring to FIG. 1B, example 100B depicts a MOPA architecture that includes multiple singlemode lasers with an external signal combiner 150, where singlemode outputs from n singlemode lasers (where n is greater than one) are provided to an external signal combiner 150, which then combines the n singlemode outputs to provide a multimode output via a delivery cable 160. For example, the singlemode outputs from n singlemode lasers may be provided to the external signal combiner 150 via n separate fibers, which may then be twisted, tapered, fused, and spliced to the delivery cable 160. Alternatively, the external signal combiner 150 may include a glass enclosure (e.g., a capillary tube), in which case the n separate fibers are input to the external signal combiner 150, tapered within a taper region of the glass enclosure, and spliced to the delivery cable 160. However, although an external signal combiner 150 can be used in this way to combine multiple lasers and scale power, the external signal combiner 150 increases cost and sacrifices brightness.

Some implementations described herein relate to a laser architecture that includes a multicore fiber that may support multiple independent singlemode lasers and a high-brightness signal combiner, which may be integrated with the multicore fiber to improve power scaling performance in a MOPA laser architecture or other monolithic fiber laser. For example, as described above, the master oscillator in a MOPA laser architecture is most stable when operating in a regime that is singlemode or near singlemode. Otherwise, transverse modal instabilities can arise when oscillator dimensions are not well-controlled. Furthermore, FBGs and/or other devices that are used as HR and/or OC reflectors are generally easier to write and/or measure when the reflector devices are singlemode or near singlemode. Accordingly, integrating a multicore fiber that supports several independent singlemode lasers with a high-brightness signal combiner may be used to generate a multimode output in a manner that may increase signal power, optimize brightness, minimize cost, and/or leverage an existing laser architecture.

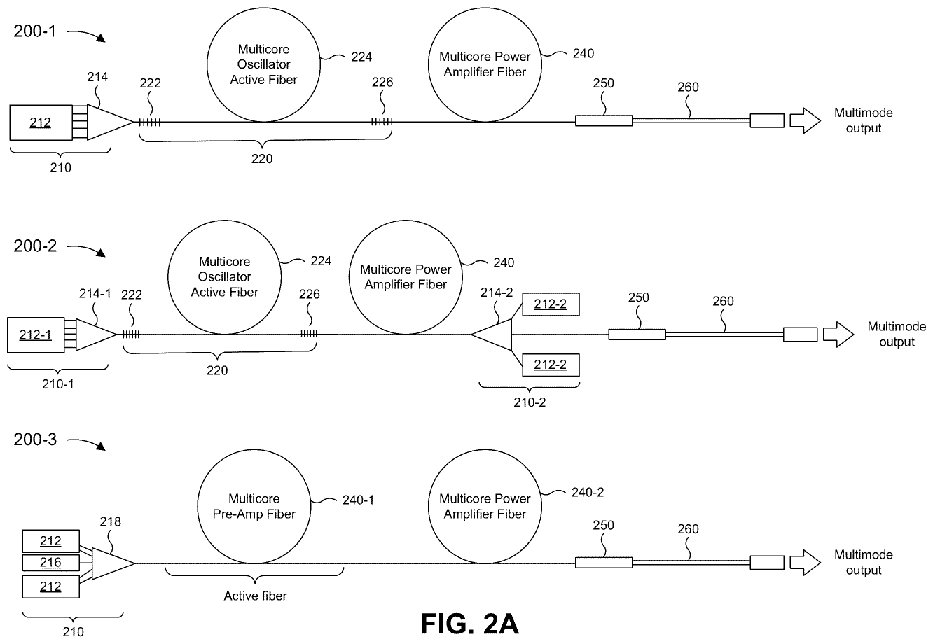

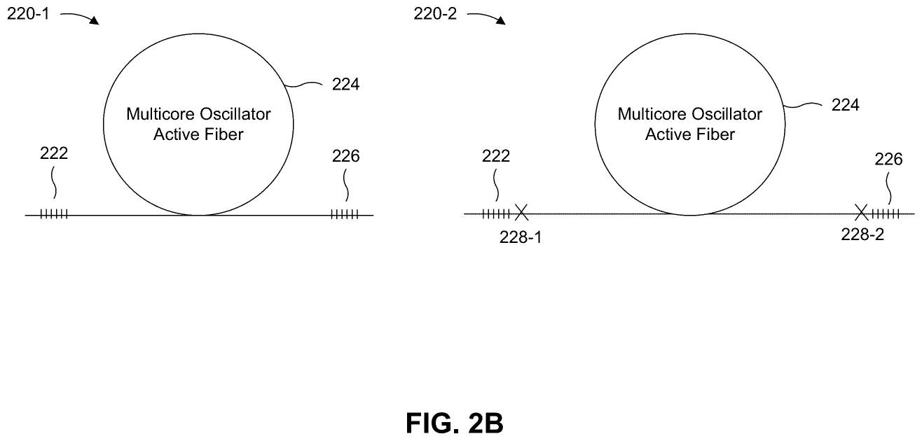

FIG. 2A is a diagram illustrating examples 200-1, 200-2, and 200-3 of a multicore laser architecture that includes an integrated high-brightness signal combiner. In example 200-1, the multicore laser architecture is an end-pumped MOPA architecture that includes a multicore oscillator 220 coupled to a multicore power amplifier fiber 240, which is integrated with a signal combiner 250 that provides a multimode output via a delivery fiber 260. Additionally, or alternatively, in example 200-2, the multicore laser architecture is a MOPA architecture configured with a bi-directional pump, including a first pump laser source 210-1 that comprises a first set of diodes 212-1 and a first combiner 214-1 provided at an input end of the multicore oscillator 220 (e.g., to provide first pump light in a light propagation direction) and a second pump laser source 210-2 that comprises a second set of diodes 212-2 and a second combiner 214-2 provided at an output end of the multicore power amplifier fiber 240 (e.g., to provide second pump light in a direction opposite from the light propagation direction). As further shown in FIG. 2A, in example 200-3, the multicore laser architecture is an end-pumped multi-stage amplifier. In this case, in addition to the diodes 212 that are configured to provide pump light, the pump laser source 210 includes a seed diode 216 that may provide signal light and a pump-signal combiner 218 that may combine the pump light provided by the diodes 212 with the signal light provided by the seed diode 216 to generate input light to a multicore laser architecture that includes a multicore pre-amplifier fiber 240-1 and a second stage multicore power amplifier fiber 240-2 integrated with a high-brightness signal combiner 250. As shown by example 200-3, using the external seed diode 216 in a PSC architecture may eliminate a need for the first reflector 222 used as the HR at the input end of the active fiber and/or the second reflector 226 used as the OC at the output end of the active fiber.

Accordingly, as described herein, the multicore laser architectures shown in FIG. 2A may each include a multi-kilowatt (kW) pump source 210 comprising a plurality of laser diodes 212 and a combiner 214 or a pump-signal combiner 218. In some implementations, the multi-kW pump source 210 may define a pump laser source configured to generate input light to the multicore laser architecture. As further shown, the multicore laser architecture may include a plurality of HR reflectors (e.g., a plurality of first FBGs) 222 provided at an input end of a multicore active fiber 224 (e.g., at an interface between the combiner 214/218 and the multicore active fiber 224), or a passive multicore fiber matched to the multicore active fiber 224. Each of the plurality of HR reflectors 222 is associated with one core of the multicore active fiber 224. Further, a plurality of OC reflectors 226 (e.g., a plurality of second FBGs) may be provided at an output end of the multicore active fiber 224 (e.g., at an interface between the output end of the multicore active fiber 224 and a passive fiber coupling into the multicore power amplifier fiber 240). Each of the plurality of OC reflectors 226 may be associated with one core of the multicore active fiber 224. Further, an HR reflector 222 associated with one core of the multicore active fiber 224 is associated with the corresponding OC reflector 226 of the same core of the multicore active fiber 224. Further, the multicore laser architecture may include a multicore oscillator 220 or a multicore pre-amplifier fiber 240-1 that may include the plurality of HR reflectors 222, the plurality of OC reflectors 226, and the multicore active fiber 224.

In examples 200-1 and 200-2, each oscillator of the multicore oscillators 220 may include one of the plurality of HR reflectors 222, one core of the multicore active fiber 224, and one of the plurality of OC reflectors 226. The input light may be converted into signal light by the multicore oscillator 220, and the signal light may then be amplified to a higher power level by the power amplifier fiber 240. For example, in some implementations, the multicore active fiber 224 may include multiple cores, with reflectors 222/226 written into the different cores of the multicore oscillator 220. In some implementations, the periods of the reflectors 222/226 may be different from one another, where varying the periods of the reflectors 222/226 allows different wavelengths to oscillate in each oscillator (e.g., in each core of the multicore oscillator active fiber 224). Alternatively, in some implementations, the periods of the reflectors 222/226 may match one another to allow a specific wavelength to oscillate in each oscillator, or one of the reflectors 222/226 may be a narrow grating that overlaps with a broader grating. Alternatively, in some implementations, a single grating may be written across the entire fiber using a femtosecond laser or the like. In a configuration where a single grating is written across the entire fiber, the entire fiber may be exposed at once to write the same grating across all cores. In any case, by providing the multicore oscillator 220 with multiple independent cores, pump-to-signal conversion may be effectively multiplied without significantly increasing SRS or other nonlinear effects. For example, a single core in the oscillator may generally generate a given amount of power (e.g., based on conversion of pump power in that core), whereby doubling, tripling, quadrupling, or otherwise multiplying the number of independently operating cores in the multicore oscillator 220 may effectively multiply the pump-to-signal conversion that occurs within the multicore oscillator 220. Furthermore, in example 200-3, the multicore pre-amplifier fiber 240-1 and/or the multicore power amplifier fiber 240-2 may comprise a multicore fiber having similar properties as the multicore oscillator 220 described herein.

In some implementations, in order to maximize stability, a multicore fiber included in a multicore laser architecture may be configured to operate in a singlemode regime. For example, as described herein, the multicore fiber may be configured to be singlemode (e.g., designed to reflect only a singlemode of light), near singlemode (e.g., within a threshold of singlemode), a single transverse mode and a single polarization mode, a single transverse mode but not a single polarization mode, or the like. In any case, by operating the multicore fiber in a singlemode regime, the multicore laser architecture may avoid transverse modal instabilities that could otherwise arise if the parameters of the multicore active fiber or any other signal-carrying fiber within the multicore fiber were not well-controlled. Furthermore, fabricating multiple independent singlemode or near singlemode cores within one active fiber may simplify techniques used to write and/or measure the FBGs or other reflectors configured to operate as the HR reflector and/or the OC reflector. Accordingly, as described herein, the multicore laser architectures shown in FIG. 2A include one or more multicore fibers with multiple independent singlemode or near singlemode cores that may be fabricated within one fiber, which increases pump-to-signal conversion, reduces SRS gain, reduces photo darkening, and maintains stability coming out of the multicore fiber. In this way, a signal power from the multicore fiber may be increased, which reduces inversion and/or heating in the subsequent stage(s) that include the power amplifier(s) fiber 240. Additionally, or alternatively, more than one mode may be carried in one or more cores of the multicore fiber. For example, in some implementations, the FBGs or other reflectors configured to operate as the HR reflector and/or the OC reflector may be used to achieve singlemode lasing in a multimode fiber, because the higher order modes would have different resonance wavelengths (e.g., starting with a slightly multimoded fiber, the FBG(s) could be used to give near singlemode performance, which may ease manufacturing tolerances).

In some implementations, the independent active fiber cores that are included within the multicore oscillator 220 can have different HR reflectors 222 and/or OC reflectors 226 that are fabricated to reflect different wavelengths prior to launching into the multicore power amplifier fiber 240 (e.g., each core of the active fiber may have a pair of FBGs 222/226 or other devices that are fabricated for a specific wavelength and used as the HR reflector 222 and the OC reflector 226 for a corresponding core, whereby each oscillator may function as an independent laser with different wavelength(s) within the multicore active fiber 224). Additionally, or alternatively, rather than fabricating both the HR reflector 222 and the OC reflector 226 for a specific wavelength, only one reflector (e.g., the HR reflector 222) may be fabricated for each wavelength while the other reflector (e.g., the OC reflector 226) may be a wide-bandwidth grating. In this way, undesirable coherence effects may be suppressed when transitioning to the stages associated with the multicore power amplifier fiber 240, which may be addressed by having a passive fiber between the multicore oscillator 220 and the multicore power amplifier fiber 240 in examples 200-1, 200-2 or between the multicore pre-amplifier fiber 240-1 and the second stage multicore power amplifier in example 200-3. In some implementations, brightness between the multicore fiber 220/240-1 and the multicore power amplifier fiber 240/240-2 can be increased by adding a mode-matched passive fiber (e.g., a quarter-pitch graded index fiber or an equivalent step index fiber). The multicore fiber can also be used with different pump wavelengths within the same pump combiner to enable more efficient conversion within the oscillator cores and later amplifier stage(s).

Referring to FIG. 2B, in a first configuration, a multicore oscillator 220-1 that may be used in a multicore laser architecture with an integrated high-brightness signal combiner comprises a multicore active fiber 224 that has a plurality of gratings (e.g., HR gratings 222 and OC gratings 226) fabricated directly into the independent active cores of the multicore active fiber 224. For clarity, only one of the plurality of HR gratings 222 and only one of the plurality of OC 226 gratings are shown in FIG. 2B, although in some implementations a plurality of gratings may be written into a respective plurality of cores. In this case, the single active fiber 224 includes multiple doped cores that, in cooperation with the associated FBGs 222/226, act as independent oscillators and are separated from each other to satisfy a threshold level of crosstalk. For example, in some implementations, the multiple doped cores may be separated from each other to avoid or suppress crosstalk between the cores or to minimize a level of crosstalk between the cores. Alternatively, in some implementations, the separation between the cores may be reduced to enable a threshold level of crosstalk between the cores (e.g., in applications where crosstalk is desired, such as coherent beam combining, in which case the separation between the cores may be controlled to achieve a fixed phase relationship between the cores).

In the first configuration of the multicore oscillator 220-1, one or more FBGs used as the HR reflector 222 at the input end of the multicore oscillator 220-1 and/or one or more FBGs used as the OC reflector 226 at the output end of the multicore oscillator 220-1 may be written directly into each core on both sides of the active fiber 224 with a femtosecond (FS) laser or other means. For example, in some implementations, a first FBG on the input end of the active fiber 224 may be configured to operate as the HR reflector 222 (e.g., with a reflectivity around 99%) and a second FBG on the output side of the active fiber 224 may be configured to operate as the OC reflector 226 (e.g., with a reflectivity around 10-20%). Alternatively, FIG. 2B depicts a second configuration of the multicore oscillator 220-2, which includes matched active and passive fibers. As described herein, matched active and passive fibers may generally have the same number of cores, the same relative positioning of cores within the fibers, and/or similar mode sizes and numerical apertures (NAs). Furthermore, as described herein, matched active and passive fibers may be oriented so that respective cores in the fibers align when the fibers are spliced together or otherwise coupled. In the case of the second configuration for the multicore oscillator 220-2, matched multicore passive fibers with the HR reflector 222 and the OC reflector 226 (e.g., respective FBGs) written in each core may be spliced to both ends of a matched multicore active fiber 224. For example, reference numbers 228-1 and 228-2 depict respective splice points where the matched multicore passive fibers are spliced to both ends of the matched multicore active fiber 224. Furthermore, similar to the first configuration for the multicore oscillator 220-1, a first FBG on the input end of the active fiber 224 acts as the HR reflector 222 and a second FBG on the output end of the active fiber 224 acts as the OC reflector 226.

As indicated above, FIGS. 2A-2B are provided as examples. Other examples may differ from what is described with regard to FIGS. 2A-2B. The number and arrangement of devices shown in FIGS. 2A-2B are provided as examples. In practice, there may be additional devices, fewer devices, different devices, or differently arranged devices than those shown in FIGS. 2A-2B. Furthermore, two or more devices shown in FIGS. 2A-2B may be implemented within a single device, or a single device shown in FIGS. 2A-2B may be implemented as multiple, distributed devices. Additionally, or alternatively, a set of devices (e.g., one or more devices) shown in FIGS. 2A-2B may perform one or more functions described as being performed by another set of devices shown in FIGS. 2A-2B.

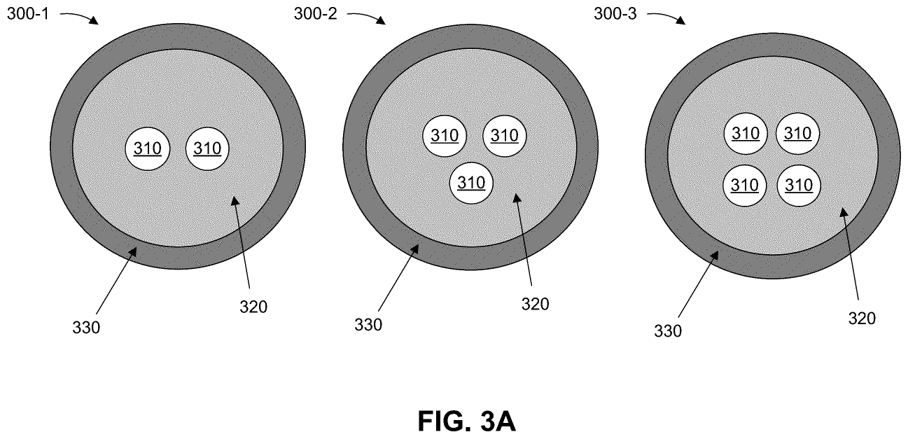

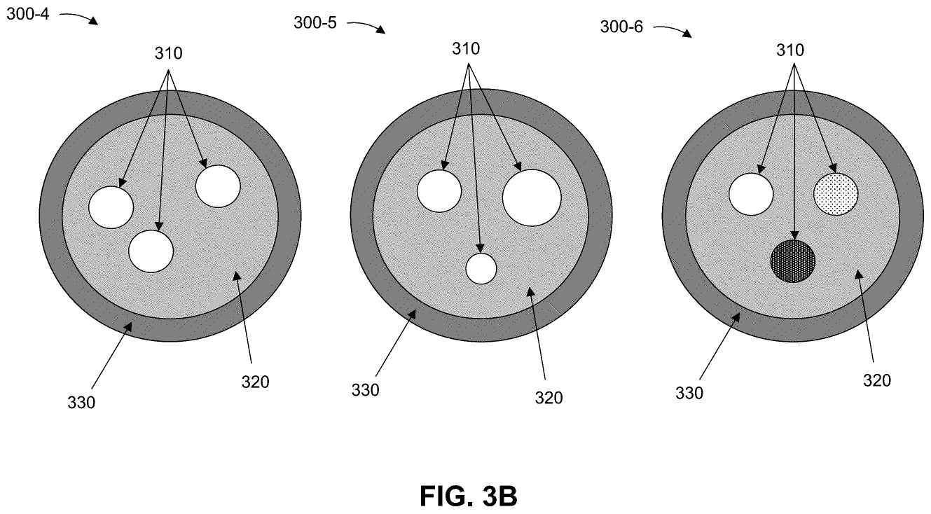

FIGS. 3A-3B are diagrams illustrating example cross-sections of a multicore active fiber that may be used in a multicore laser architecture that includes an integrated high-brightness signal combiner. FIGS. 3A-3B are diagrams illustrating example cross-sections 300-1 through 300-6 of a multicore active fiber that may be used in a multicore laser architecture with an integrated high-brightness signal combiner (e.g., in the multicore laser architectures shown in FIG. 2A). For example, as shown in FIGS. 3A-3B, the multicore active fiber may generally include an inner cladding 320, an outer cladding 330 surrounding the inner cladding 320, and multiple singlemode fiber cores 310 that are embedded in the inner cladding and used to convert pump light from a pump laser source into signal light that is launched into a power amplifier and/or to transmit combined pump and signal light into a power amplifier.

Referring to FIG. 3A, cross-sections 300-1, 300-2, and 300-3 depict example configurations where the multicore active fiber includes two, three, or four identical cores 310 (e.g., the cores 310 have a uniform doping and a uniform core size) with a uniform separation from each other to avoid crosstalk between the cores 310 and/or to satisfy a threshold level of crosstalk between the cores 310. However, the multicore active fiber may generally include N cores, where N is an integer greater than one (1).

Additionally, or alternatively, referring to FIG. 3B, cross-sections 300-4, 300-5, and 300-6 depict example configurations where the multicore active fiber includes multiple cores 310 associated with different parameters. For example, as shown by cross-section 300-4, the multicore active fiber may include multiple cores 310 with different core separations (e.g., a first core 310 may be separated from a second core 310 by a first distance and separated from a third core 310 by a second distance that is different from the first distance). Additionally, or alternatively, as shown by cross-section 300-5, the multicore active fiber may include multiple cores 310 with different core sizes (e.g., different core diameters). Additionally, or alternatively, as shown by cross-section 300-6, the multicore active fiber may include multiple cores 310 with a different doping in each core 310 (shown in FIG. 3B by variations in the fill patterns of the different cores 310). In other examples (not explicitly illustrated), the multiple cores 310 may be twisted around a center axis of the active fiber, which is equivalent to bending of the cores 310 and may ensure that more singlemode signal is output by the multicore oscillator. In some implementations, the period of the twisting may be adjusted, which causes the bending diameter to change. Furthermore, in some implementations, twisting the cores 310 may result in a more uniform pump absorption across the different cores 310.

As indicated above, FIGS. 3A-3B are provided as examples. Other examples may differ from what is described with regard to FIGS. 3A-3B. The number and arrangement of devices shown in FIGS. 3A-3B are provided as examples. In practice, there may be additional devices, fewer devices, different devices, or differently arranged devices than those shown in FIGS. 3A-3B. Furthermore, two or more devices shown in FIGS. 3A-3B may be implemented within a single device, or a single device shown in FIGS. 3A-3B may be implemented as multiple, distributed devices. Additionally, or alternatively, a set of devices (e.g., one or more devices) shown in FIGS. 3A-3B may perform one or more functions described as being performed by another set of devices shown in FIGS. 3A-3B.

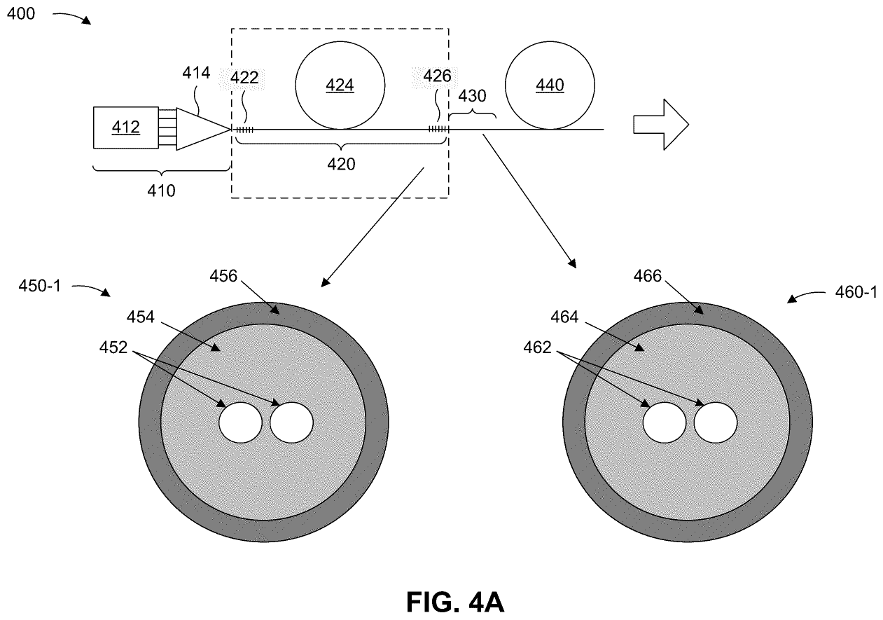

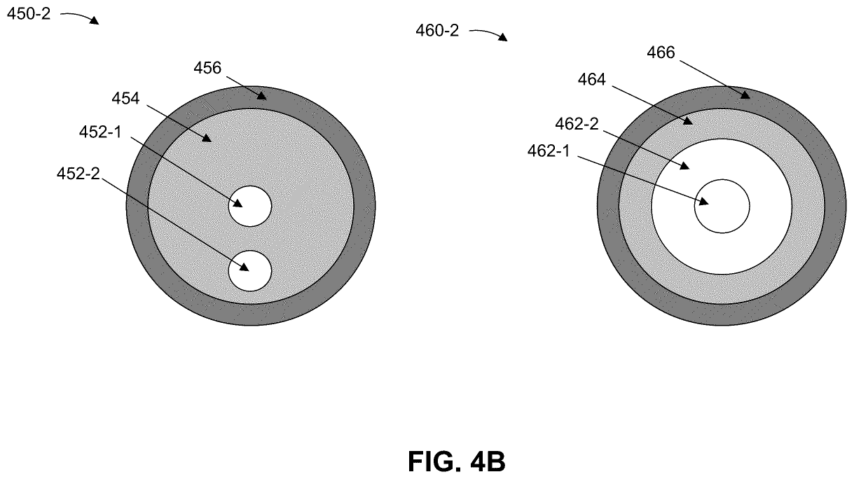

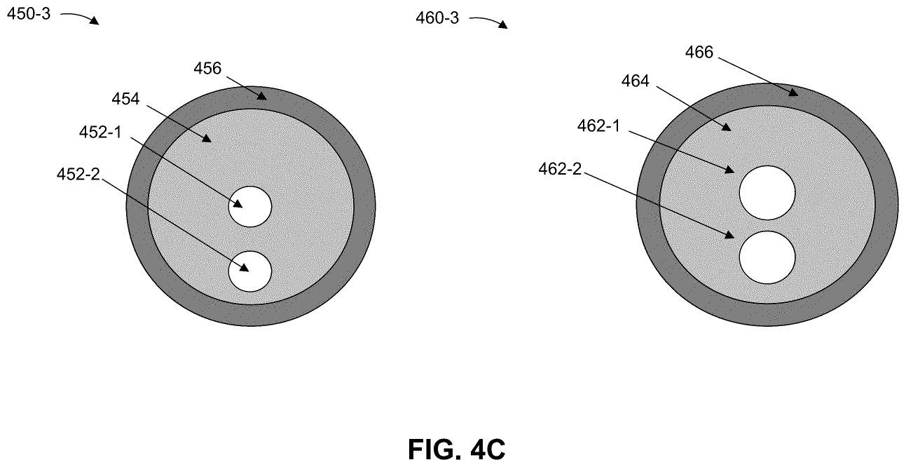

FIGS. 4A-4C are diagrams illustrating an example of a MOPA laser architecture 400 and example interfaces to couple a multicore oscillator 420 and a power amplifier 440 in the MOPA laser architecture. For example, as shown in FIG. 4A, the MOPA laser architecture 400 may include a multi-kW pump 410 that comprises a plurality of laser diodes 412 and a combiner 414, which may collectively define a pump laser source configured to generate input light to the MOPA laser architecture 400. As further shown, the MOPA laser architecture may include a plurality of HR reflectors 422 (e.g., a plurality of first FBGs) provided at an input end of the multicore oscillator 420 (e.g., at an interface between the combiner 414 and an active fiber 424), with one HR reflector 422 provided at the input end of each core of the active fiber 424. As further shown, the MOPA laser architecture 400 may include a plurality of OC reflectors 426 (e.g., a plurality of second FBGs) at an output end of the multicore oscillator 420 (e.g., at an interface between the output end of the active fiber 424 and a passive or active output fiber 430 coupling into the power amplifier 440), with one OC reflector 426 provided at the output end of each core of the active fiber 424.

In some implementations, the output from the multicore oscillator 420 is spliced to a multicore power amplifier 440 that is matched to the multicore oscillator 420 for a final amplification stage. In general, as described herein, individual cores in the multicore oscillator 420 and the multicore power amplifier 440 each function as independent singlemode lasers. Furthermore, in some implementations, twisting may be applied to the multicore fiber used for the multicore oscillator 420 and/or the multicore power amplifier 440 to help with uniform pump absorption across the various cores. In some implementations, the multicore fiber used for the multicore power amplifier 440 may include multiple symmetric cores, multiple concentric cores, multiple offset cores, or other suitable core configurations that are matched to the output from the multicore oscillator 220.

For example, referring to FIG. 4A, reference number 450-1 depicts an example cross-section of the output end of the multicore oscillator 420, which includes two active cores 452 that are embedded in a fused silica inner cladding 454 surrounded by a fluorine (F)-doped outer cladding 456. As further shown, reference number 460-1 depicts an example cross-section of the input end of the multicore power amplifier 440 that is spliced to or integrated with the output of the multicore oscillator 420. As shown, the multicore power amplifier 440 includes two active cores 462 matched to the two active cores 452 of the multicore oscillator 420, a fused silica inner cladding 464 that surrounds the two active cores 462 and is matched to the fused silica inner cladding 454 of the multicore oscillator 420, and an F-doped outer cladding 466 that surrounds the fused silica inner cladding 464 and is matched to the F-doped outer cladding 456 of the multicore oscillator 420.

In another example, referring to FIG. 4B, reference number 450-2 depicts an example cross-section in which the multicore oscillator 420 includes a central active core 452-1 and an offset active core 452-2 in a fused silica inner cladding 454 surrounded by an F-doped outer cladding 456. As shown by reference number 460-2, the cross-section of the multicore oscillator 420 is matched to a dual concentric core output fiber (e.g., a passive or active output fiber) that includes an inner core 462-1 matched to the central core 452-1 of the multicore oscillator 420, an outer core 462-2 matched to the offset core 452-2 of the multicore oscillator 420, a fused silica inner cladding 464 surrounding the dual concentric cores 462-1, 462-2, and an F-doped outer cladding 466 surrounding the fused silica inner cladding 464.

In another example, referring to FIG. 4C, reference number 450-3 depicts an example cross-section in which the multicore oscillator 420 has the same configuration as shown in FIG. 4B. As shown by reference number 460-3, the cross-section of the multicore oscillator 420 is matched to a dual offset core output fiber (e.g., a passive or active output fiber) that includes a central core 462-1 matched to the central core 452-1 of the multicore oscillator 420, an offset core 462-2 matched to the offset core 452-2 of the multicore oscillator 420, a fused silica inner cladding 464 surrounding the dual offset cores 462-1, 462-2, and an F-doped outer cladding 466 surrounding the fused silica inner cladding.

In other examples (not explicitly illustrated), the multicore power amplifier fiber 440 may have a confined doping, which is similar to a tapered core and may better confine the mode after the signal from the multicore oscillator 420 is launched into the multicore power amplifier fiber 440. Additionally, or alternatively, the active fiber 424 of the multicore oscillator 420 may include a single center offset core 452 that may be twisted, where the mode in the single center offset core can be well-managed by controlling a period of the twisting.

As indicated above, FIGS. 4A-4C are provided as examples. Other examples may differ from what is described with regard to FIGS. 4A-4C. The number and arrangement of devices shown in FIGS. 4A-4C are provided as examples. In practice, there may be additional devices, fewer devices, different devices, or differently arranged devices than those shown in FIGS. 4A-4C. Furthermore, two or more devices shown in FIGS. 4A-4C may be implemented within a single device, or a single device shown in FIGS. 4A-4C may be implemented as multiple, distributed devices. Additionally, or alternatively, a set of devices (e.g., one or more devices) shown in FIGS. 4A-4C may perform one or more functions described as being performed by another set of devices shown in FIGS. 4A-4C.

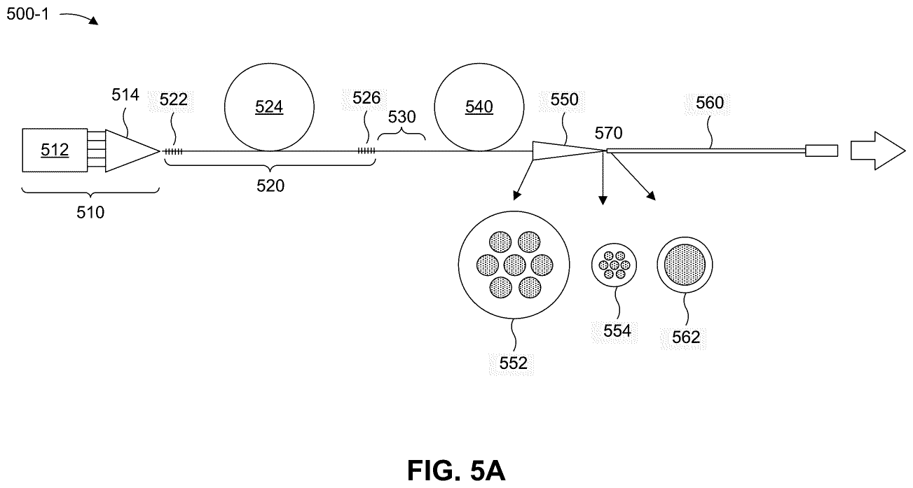

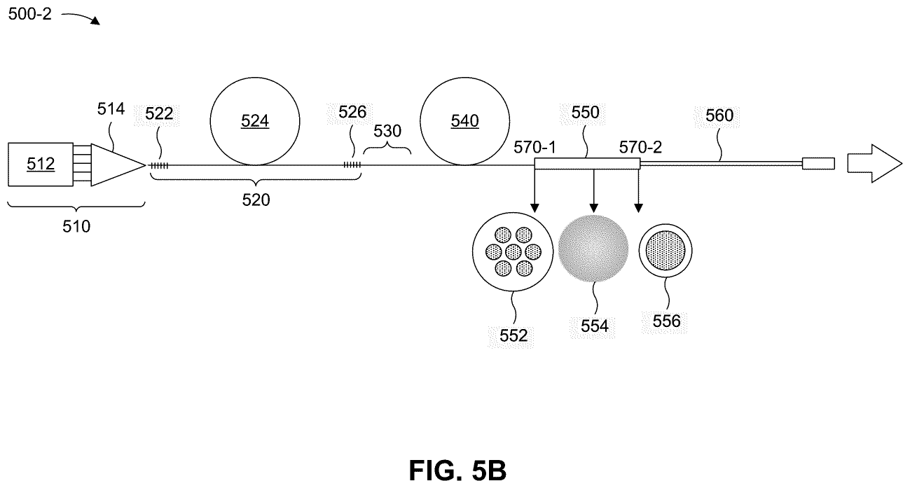

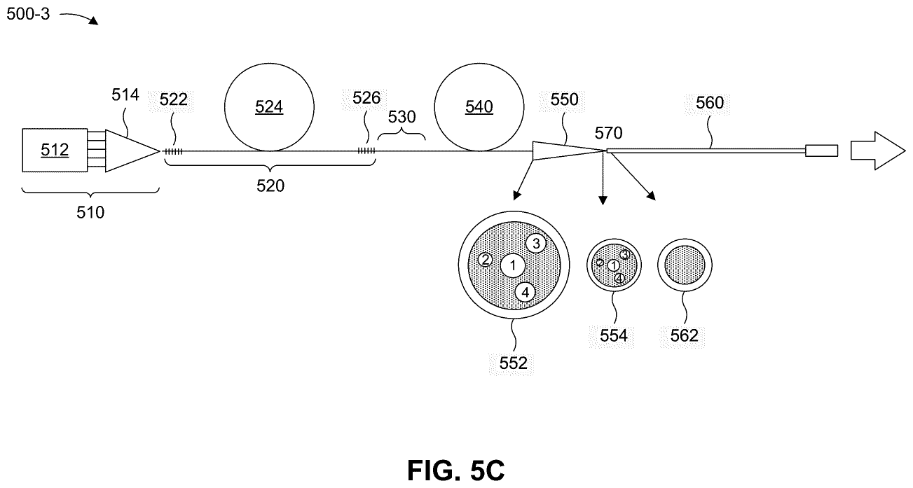

FIGS. 5A-5C are diagrams illustrating examples 500-1, 500-2, and 500-3 of a multicore laser architecture with an integrated high-brightness signal combiner. For example, as shown in FIGS. 5A-5C, examples 500-1, 500-2, and 500-3 each include a MOPA laser architecture that comprises a multi-KW pump 510, which includes a plurality of laser diodes 512 and a combiner 514 that may define a pump laser source configured to generate input light to the MOPA laser architecture. Alternatively, in some implementations, the multi-kW pump 510 may include a seed diode (not shown) and a pump-signal combiner 514 that may generate the input light to the multicore laser architecture. In some implementations, as further shown, the multicore laser architecture may include a multicore oscillator 520 that comprises a plurality of HR reflectors 522 (e.g., a plurality of first FBGs) provided at an input end of the multicore oscillator 520 (e.g., at an interface between the combiner 514 and an active fiber 524 of the multicore oscillator 520) and a plurality of OC reflectors 526 (e.g., a plurality of second FBGs) at an output end of the multicore oscillator 520 (e.g., at an interface between the output end of the active fiber 524 and a passive or active output fiber 530) and a multicore power amplifier 540. As further shown in

FIGS. 5A-5C, an output from the multicore power amplifier 540 may be provided to an integrated signal combiner 550 that combines singlemode inputs received from the various cores of the multicore power amplifier 540 into a multimode output that is then provided via a delivery fiber 560.

For example, referring to FIG. 5A, example 500-1 depicts a multicore laser architecture that may be integrated with a signal combiner 550 with a passive taper. For example, as shown in FIG. 5A, the output from a multicore laser with symmetric cores may be tapered adiabatically with a roughly 3× taper ratio, and then spliced to a multimode delivery fiber (or delivery cable) 560. For example, reference number 552 depicts a cross-section of the integrated signal combiner 550 at an input interface where the singlemode inputs are received from the multicore laser architecture, reference number 554 depicts a cross-section of the integrated signal combiner 550 at a splice point 570 where the signal combiner 550 is spliced to the multimode delivery fiber 560, and reference number 562 depicts a cross-section of the multimode delivery fiber 560. Accordingly, in example 500-1, modes from the individual cores of the multicore laser architecture may expand adiabatically into the cladding as the fiber is tapered. In some implementations, the taper ratio may be configured to be sufficiently large to ensure that modes emerge fully out of the cores in order to optimize brightness. Otherwise, in cases where the modes from the individual cores are not well-controlled, the modes may couple into several modes in the multimode delivery fiber 560, which may result in decreased brightness.

Furthermore, in some implementations, a surface treatment may be applied to the integrated signal combiner 550, to cause the integrated signal combiner 550 to have a hydrophobic surface coating. For example, in some implementations, a hexamethyldisilazane (HMDS) (H₃C)₃Si chemical treatment layer may be applied to the surface of the signal combiner 550, which may result in a changed chemistry of the surface of the signal combiner 550. In this case, hydroxyl (OH) groups (silanol terminations) on a surface of the signal combiner 550 may be reacted with (methyl groups of) the HMDS to form a monolayer protective coating (e.g., an HMDS layer) on the signal combiner 550. In other words, rather than a silica-based optical fiber (or other type of optical fiber or optical component) with a surface layer of oxygen molecules, each having a hydrogen molecule (e.g., silanol groups), the signal combiner 550 includes a surface layer of oxygen molecules, each having an HMDS group. The exposed HMDS groups form a hydrophobic surface, thereby preventing or reducing atmospheric water molecule based deposition surface contaminants on the signal combiner 550 and/or microcrack propagation via hydrolysis reaction. In this way, the use of an HMDS treatment (or another type of treatment) can reduce a need to provide a recoating or housing for the signal combiner 550, thereby reducing manufacturing complexity and/or enabling further miniaturization.

Additionally, or alternatively, as shown in FIG. 5B, and by example 500-2, the signal combiner 550 may comprise a quarter-pitch graded index (GI) fiber. For example, as shown in FIG. 5B, the output from a multicore laser architecture may be spliced to a matched piece of graded index fiber with a quarter-pitch length at a first splice point 570-1, and the graded index fiber may then be spliced to the multimode delivery fiber (or delivery cable) 560 at a second splice point 570-2. For example, in FIG. 5B, reference number 552 depicts a cross-section of the graded index fiber at the first splice point 570-1 where the singlemode inputs are received from the multicore laser architecture, reference number 554 depicts a cross-section of the graded index fiber at a midpoint of the quarter-pitch length of the graded index fiber, and reference number 556 depicts a cross section of the graded index fiber at the second splice point 570-2. In some implementations, relative to example 500-1 in FIG. 5A, an additional splice 570 in the fiber assembly could potentially introduce more loss. Furthermore, in a similar manner as described above with reference to FIG. 5A, the modes from the individual cores may couple into several modes in the multimode delivery fiber 560 in cases where the modes from the individual cores are not well-controlled, which may result in decreased brightness.

Additionally, or alternatively, referring to FIG. 5C, example 500-3 depicts a multicore laser architecture that may be integrated with a signal combiner 550 with an active taper. For example, in FIG. 5C, the multicore laser architecture and the multimode delivery fiber 560 are well-matched, in that the number of cores in the multicore laser architecture matches the number of supported modes in the multimode delivery fiber 560, and each core in the multicore in the multicore laser architecture has a core size and an NA that matches a corresponding mode in the multimode delivery fiber 560 at an interface between the signal combiner 550 and the multimode delivery fiber 560. For example, in a multicore fiber with four (4) cores, the 4 cores are matched to a delivery fiber 560 that supports 4 modes (e.g., LP01, LP11X, LP11Y, and LP02 modes). In some implementations, the core sizes and the NAs in the multicore laser architecture are fixed in such a way that when a precise taper is applied to the multicore fiber to form the integrated signal combiner 550, each mode from the multicore fiber matches an exact mode in the multimode delivery fiber 560. For example, in some implementations, a first tapered core may directly match an LP01 mode in the multimode delivery fiber 560, a second tapered core may directly match an LP11X mode in the multimode delivery fiber 560, a third tapered core may directly match an LP11Y mode in the multimode delivery fiber 560, and a fourth tapered core may directly match an LP02 mode in the multimode delivery fiber 560. Furthermore, in a similar manner as described above with reference to FIG. 5A, a surface treatment may be applied to the integrated signal combiner 550, to cause the integrated signal combiner 550 to have a hydrophobic surface coating to prevent or reduce atmospheric water molecule based deposition surface contaminants on the signal combiner 550 and/or microcrack propagation via hydrolysis reaction.

As indicated above, FIGS. 5A-5C are provided as examples. Other examples may differ from what is described with regard to FIGS. 5A-5C. The number and arrangement of devices shown in FIGS. 5A-5C are provided as examples. In practice, there may be additional devices, fewer devices, different devices, or differently arranged devices than those shown in FIGS. 5A-5C. Furthermore, two or more devices shown in FIGS. 5A-5C may be implemented within a single device, or a single device shown in FIGS. 5A-5C may be implemented as multiple, distributed devices. Additionally, or alternatively, a set of devices (e.g., one or more devices) shown in FIGS. 5A-5C may perform one or more functions described as being performed by another set of devices shown in FIGS. 5A-5C.

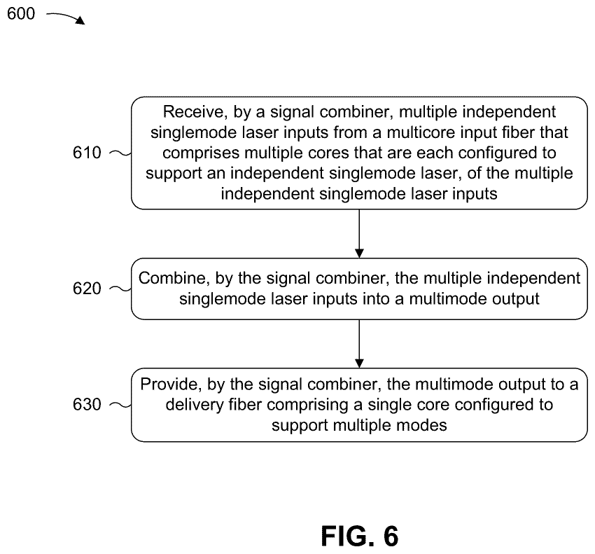

FIG. 6 is a flowchart of an example process 600 for operating an optical system that includes a multicore laser architecture with an integrated high-brightness signal combiner. In some implementations, one or more process blocks of FIG. 6 are performed by a signal combiner (e.g., signal combiner 250, signal combiner 550, or the like).

As shown in FIG. 6, process 600 may include receiving multiple independent singlemode laser inputs from a multicore fiber laser that comprises multiple cores that are each configured to support an independent singlemode laser, of the multiple independent singlemode laser inputs (block 610). For example, the signal combiner 250, the signal combiner 550, or the like may receive multiple independent singlemode laser inputs from a multicore fiber laser 200-1, 200-2, and/or 200-3, a MOPA laser architecture 400, or the like that comprises multiple cores that are each configured to support an independent singlemode laser, of the multiple independent singlemode laser inputs, as described above.

As further shown in FIG. 6, process 600 may include combining the multiple independent singlemode laser inputs into a multimode output (block 620). For example, the signal combiner 250, the signal combiner 550, or the like may combine the multiple independent singlemode laser inputs into a multimode output, as described above.

As further shown in FIG. 6, process 600 may include providing the multimode output to a delivery fiber comprising a single core configured to support multiple modes (block 630). For example, the signal combiner 250, the signal combiner 550, or the like may provide the multimode output to a delivery fiber 260, 560, or the like comprising a single core configured to support multiple modes, as described above.

Process 600 may include additional implementations, such as any single implementation or any combination of implementations described below and/or in connection with one or more other processes described elsewhere herein.

In a first implementation, the signal combiner comprises multiple symmetric cores, to receive the multiple independent singlemode laser inputs from the multicore fiber laser, that taper adiabatically to a splice point with the delivery fiber.

In a second implementation, alone or in combination with the first implementation, the signal combiner comprises a graded index fiber with a quarter-pitch length that is spliced to the multicore fiber laser at a first splice point and spliced to the delivery fiber at a second splice point.

In a third implementation, alone or in combination with one or more of the first and second implementations, a quantity of the multiple independent singlemode laser inputs received at the signal combiner from the multicore fiber laser equals a quantity of the multiple modes supported in the delivery fiber.

In a fourth implementation, alone or in combination with one or more of the first through third implementations, the multiple cores of the multicore fiber laser have respective core sizes and numerical apertures that match corresponding modes in the delivery fiber at a splice point between the signal combiner and the delivery fiber.

In a fifth implementation, alone or in combination with one or more of the first through fourth implementations, the multicore fiber laser is an end-pumped MOPA laser with a pump laser source and a combiner coupled to an input end of a multicore oscillator and a multicore power amplifier.

In a sixth implementation, alone or in combination with one or more of the first through fifth implementations, the multicore fiber laser is a MOPA laser with a bi-directional pump that comprises a first pump laser source and a first combiner coupled to an input end of a multicore oscillator and a multicore power amplifier, and a second pump laser source and a second combiner coupled to an output end of the multicore oscillator and the multicore power amplifier, wherein the first pump laser source and the second pump laser source are configured to generate pump light that propagates in opposite directions.

In a seventh implementation, alone or in combination with one or more of the first through sixth implementations, the multicore fiber laser is an end-pumped multi-state amplifier that comprises a pump laser source, a seed laser source, and a combiner coupled to an input end of a multicore pre-amplifier and a multicore power amplifier.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical system, comprising:
a pump laser source;
a multicore fiber laser comprising:
an oscillator comprising an input side coupled to the pump laser source and an output side, wherein the oscillator comprises:
an active fiber comprising multiple singlemode active fiber cores to convert pump light generated by the pump laser source into signal light;
multiple first reflectors, respectively associated with the multiple singlemode active fiber cores, that are each configured to operate as a high reflector (HR) on the input side of the oscillator; and
multiple second reflectors, respectively associated with the multiple singlemode active fiber cores, that are each configured to operate as an output coupler (OC) on the output side of the oscillator; and
a power amplifier coupled to the output side of the oscillator, wherein the power amplifier comprises multiple cores that are matched to the multiple singlemode active fiber cores of the oscillator;
a multimode delivery fiber; and
a signal combiner, integrated with the multicore fiber laser, configured to receive multiple singlemode laser inputs from the multicore fiber laser and to combine the multiple singlemode laser inputs into a multimode output that is provided to the multimode delivery fiber.

2. The optical system of claim 1, wherein the signal combiner comprises multiple symmetric cores, to receive the multiple singlemode laser inputs from the multicore fiber laser, that taper adiabatically to a splice point with the multimode delivery fiber.

3. The optical system of claim 1, wherein the signal combiner comprises a graded index fiber with a quarter-pitch length that is spliced to the multicore fiber laser at a first splice point and spliced to the multimode delivery fiber at a second splice point.

4. The optical system of claim 1, wherein a quantity of the multiple singlemode laser inputs from the multicore fiber laser equals a quantity of supported modes in the multimode delivery fiber.

5. The optical system of claim 1, wherein the multiple singlemode active fiber cores of the oscillator and the multiple cores of the power amplifier have respective core sizes and numerical apertures that match corresponding modes in the multimode delivery fiber at a splice point between the signal combiner and the multimode delivery fiber.

6. The optical system of claim 1, wherein the signal combiner comprises a hydrophobic surface coating.

7. An optical system, comprising:
a multicore input fiber comprising multiple cores that are each configured to support an independent singlemode laser;
a delivery fiber comprising a single core configured to support multiple modes; and
a signal combiner, coupled to the multicore input fiber and to the delivery fiber,
wherein the signal combiner is configured to receive multiple independent singlemode laser inputs from the multicore input fiber and to combine the multiple independent singlemode laser inputs into a multimode output that is provided to the delivery fiber.

8. The optical system of claim 7, wherein the signal combiner comprises multiple symmetric cores, to receive the multiple independent singlemode laser inputs from the multicore input fiber, that taper adiabatically to a splice point with the delivery fiber.

9. The optical system of claim 7, wherein the signal combiner comprises a graded index fiber with a quarter-pitch length that is spliced to the multicore input fiber at a first splice point and spliced to the delivery fiber at a second splice point.

10. The optical system of claim 7, wherein a quantity of the multiple independent singlemode laser inputs received at the signal combiner from the multicore input fiber equals a quantity of the multiple modes supported in the delivery fiber.

11. The optical system of claim 7, wherein the multiple cores of the multicore input fiber have respective core sizes and numerical apertures that match corresponding modes in the delivery fiber at a splice point between the signal combiner and the delivery fiber.

12. The optical system of claim 7, wherein the signal combiner comprises a hydrophobic surface coating.

13. A method for operating an optical system, comprising:
receiving, by a signal combiner, multiple independent singlemode laser inputs from a multicore fiber laser that comprises multiple cores that are each configured to support an independent singlemode laser, of the multiple independent singlemode laser inputs;
combining, by the signal combiner, the multiple independent singlemode laser inputs into a multimode output; and
providing, by the signal combiner, the multimode output to a delivery fiber comprising a single core configured to support multiple modes.

14. The method of claim 13, wherein the signal combiner comprises multiple symmetric cores, to receive the multiple independent singlemode laser inputs from the multicore fiber laser, that taper adiabatically to a splice point with the delivery fiber.

15. The method of claim 13, wherein the signal combiner comprises a graded index fiber with a quarter-pitch length that is spliced to the multicore fiber laser at a first splice point and spliced to the delivery fiber at a second splice point.

16. The method of claim 13, wherein a quantity of the multiple independent singlemode laser inputs received at the signal combiner from the multicore fiber laser equals a quantity of the multiple modes supported in the delivery fiber.

17. The method of claim 13, wherein the multiple cores of the multicore fiber laser have respective core sizes and numerical apertures that match corresponding modes in the delivery fiber at a splice point between the signal combiner and the delivery fiber.

18. The method of claim 13, wherein the multicore fiber laser is an end-pumped master oscillator power amplifier (MOPA) laser with a pump laser source and a combiner coupled to an input end of a multicore oscillator and a multicore power amplifier.

19. The method of claim 13, wherein the multicore fiber laser is a master oscillator power amplifier (MOPA) laser with a bi-directional pump that comprises:
a first pump laser source and a first combiner coupled to an input end of a multicore oscillator and a multicore power amplifier; and
a second pump laser source and a second combiner coupled to an output end of the multicore oscillator and the multicore power amplifier,
wherein the first pump laser source and the second pump laser source are configured to generate pump light that propagates in opposite directions.

20. The method of claim 13, wherein the multicore fiber laser is an end-pumped multi-state amplifier that comprises a pump laser source, a seed laser source, and a combiner coupled to an input end of a multicore pre-amplifier and a multicore power amplifier.
